(19) United States
(12) Patent Application Publication
(10) Pub. No.: US 2019/0188114 A1
(43) Pub. Date: Jun. 20, 2019

(54) GENERATION OF DIAGNOSTIC EXPERIMENTS FOR EVALUATING COMPUTER SYSTEM PERFORMANCE ANOMALIES

(71) Applicant: CA, Inc., New York, NY (US)

(72) Inventors: Robin Hopper, Prague (CZ); Alex Kingham, Prague (CZ); Ronald Colmone, Arlington Heights, IL (US); Marc Solé Simo, Sant Just Desvern (ES); Victor Muntés Mulero, Barcelona (ES)

(21) Appl. No.: 15/846,768

(22) Filed: Dec. 19, 2017

(51) Int. Cl. G06F 11/36; G06F 11/14

(52) U.S. Cl. CPC G06F 11/3612; G06F 8/36; G06F 11/1464

(57) ABSTRACT

A method includes performing, by a processor: detecting a performance anomaly in a production computer system, generating a snapshot image of software and data that were executed on the production computer system during the performance anomaly, generating diagnostic information for the performance anomaly, communicating the diagnostic information to an experiment computer system, generating an experiment based on the diagnostic information and the snapshot image to create an experimental image, executing the experimental image on the experiment computer system to perform the experiment, and evaluating an effect of the experiment on the performance anomaly.

### BACKGROUND

The present disclosure relates to computer systems, and, in particular, to methods, systems, and computer program products for managing computer system performance.

Computer systems, such as mainframe computer systems, may include performance management software that is designed to detect and diagnose complex software performance problems to maintain an expected level of service. Two sets of performance metrics may be monitored: The first set of performance metrics defines the performance experienced by end users of the application. One example of performance is average response times under peak load. The components of the first set include load and response time where load is the volume of transactions processed by the application and response time is the time required for an application to respond to a user's actions under such a load. The second set of performance metrics measures the computational resources used by the application for the load, indicating whether there is adequate capacity to support the load, as well as possible locations of a performance bottleneck. Measurement of these quantities may establish an empirical performance baseline for the application. The baseline can then be used to detect changes in performance. Changes in performance may be correlated with external events and subsequently used to predict future changes in application performance. While performance management software may be used to collect diagnostic data on computer system performance, an administrator or other engineering staff may lack tools for analyzing the diagnostic information and generating fixes that may resolve the source of performance problems or mitigate the effects of performance problems.

### SUMMARY

In some embodiments of the inventive subject matter, a method comprises, performing by a processor: detecting a performance anomaly in a production computer system, generating a snapshot image of software and data that were executed on the production computer system during the performance anomaly, generating diagnostic information for the performance anomaly, communicating the diagnostic information to an experiment computer system, generating an experiment based on the diagnostic information and the snapshot image to create an experimental image, executing the experimental image on the experiment computer system to perform the experiment, and evaluating an effect of the experiment on the performance anomaly.

In other embodiments of the inventive subject matter, a system comprises a processor and a memory coupled to the processor and comprising computer readable program code embodied in the memory that is executable by the processor to perform: detecting a performance anomaly in a production computer system, generating a snapshot image of software and data that were executed on the production computer system during the performance anomaly, generating diagnostic information for the performance anomaly, communicating the diagnostic information to an experiment computer system, generating an experiment based on the diagnostic information and the snapshot image to create an experimental image, executing the experimental image on the experiment computer system to perform the experiment, and evaluating an effect of the experiment on the performance anomaly. Detecting the performance anomaly comprises determining that a data component response time exceeds a defined data component response time. Generating the diagnostic information comprises: identifying a code portion that accessed the data component and identifying a plurality of data objects associated with the data component.

In further embodiments of the inventive subject matter, a computer program product comprises a tangible computer readable storage medium comprising computer readable program code embodied in the medium that is executable by a processor to perform: detecting a performance anomaly in a production computer system, generating a snapshot image of software and data that were executed on the production computer system during the performance anomaly, generating diagnostic information for the performance anomaly, communicating the diagnostic information to an experiment computer system, generating an experiment based on the diagnostic information and the snapshot image to create an experimental image, executing the experimental image on the experiment computer system to perform the experiment, and evaluating an effect of the experiment on the performance anomaly. The production computer system is an IBM Parallel Sysplex computer system. The experiment computer system is a cloud computing resource.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a communication network including an experiment computer system for generating diagnostic experiments to evaluate performance anomalies in a production computer system in accordance with some embodiments of the inventive subject matter;

FIGS. 2-9 are flowcharts that illustrate operations for generating diagnostic experiments to evaluate performance anomalies in a production computer system in accordance with some embodiments of the inventive subject matter;

FIG. 10 is a data processing system that may be used to implement one or more servers in the experiment computer system and production computer system of FIG. 1 in accordance with some embodiments of the inventive subject matter;

FIG. 11 is a block diagram that illustrates a software/hardware architecture for use in the production computer system of FIG. 1 in accordance with some embodiments of the inventive subject matter; and

FIG. 12 is a block diagram that illustrates a software/hardware architecture for use in the experiment computer system of FIG. 1 in accordance with some embodiments of the inventive subject matter.

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, the term “data processing facility” includes, but it is not limited to, a hardware element, firmware component, and/or software component. A data processing system may be configured with one or more data processing facilities.

Embodiments of the inventive subject matter are described herein in the context of evaluating performance anomalies in a production mainframe computer system, such as an IBM Parallel Sysplex computer system. It will be understood, that embodiments of the inventive subject matter are not limited to IBM Parallel Sysplex computer systems, but can be applied generally to other production computer systems that are compatible with performance monitoring and diagnostic software.

Embodiments of the inventive subject matter are described herein in the context of diagnosing and evaluating performance anomalies associated with DB2 database transactions. It will be understood that embodiments of the inventive subject matter are not limited in their application to a relational database model as other database models, such as, but not limited to a flat database model, a hierarchical database model, a network database model, an object-relational database model, and a star schema database model may also be used.

Some embodiments of the inventive subject matter stem from a realization that manual investigation of computer system performance anomalies can be time consuming and costly. Experts may be brought in to review diagnostic reports and data in an attempt to characterize the cause(s) of the performance problems. Frequently, performance problems or anomalies can be categorized into one of three areas: 1) inefficient code design, 2) poor database architecture, and 3) high volume of database transactions. Embodiments of the present inventive subject matter may provide an automated system to diagnose and experimentally evaluate production computer system performance anomalies. In some embodiments of the inventive subject matter, system monitor software may be used to monitor the performance of a production computer system, i.e., a computer system that is in service for a customer or end user, to detect performance anomalies in the operation of the production computer system. Upon detection of a performance anomaly to be investigated, a snapshot image of the software and data that were executed on the production computer system during the time interval in which the performance anomaly occurred is obtained. In addition, diagnostic information for the performance anomaly is generated. The diagnostic information is communicated to an experiment computer system, which may, for example, be instantiated as part of an on-demand cloud-based computational resource or cloud computing resource. The experiment computer system may generate an experiment based on the diagnostic information and the snapshot image to create an experimental image. The experimental image may include, for example, but is not limited to, software modifications to address code bottlenecks, software modifications to address inefficient access to data components, and/or architectural changes to data components. The experiment may also include the generation of an experimental load, such as the use of data transactions with the data component that are obtained from a log of data transactions on the production computer system. When the performance anomaly is associated with batch processing, the jobs in the critical path can be identified and their sequence changed and/or certain jobs may be executed in parallel as part of the experiment. Various combinations of the software changes, data component architecture changes, transaction load, and critical path modifications can be performed as part of one or more experiments. The experiments can be generated automatically by the experiment computer system based on historical data and/or can include user input to customize one or more aspects of the experiments. The experiment(s) can be evaluated to determine the effect on the performance anomaly to see if the problem is resolved, the performance is improved/negative effects mitigated, or if the experiments had no effect on the performance anomaly, which may assist in ruling out possible causes. Based on the evaluation, a fix or performance enhancement may be determined and the production computer system may be modified to include the fix or enhancement to improve the performance thereof.

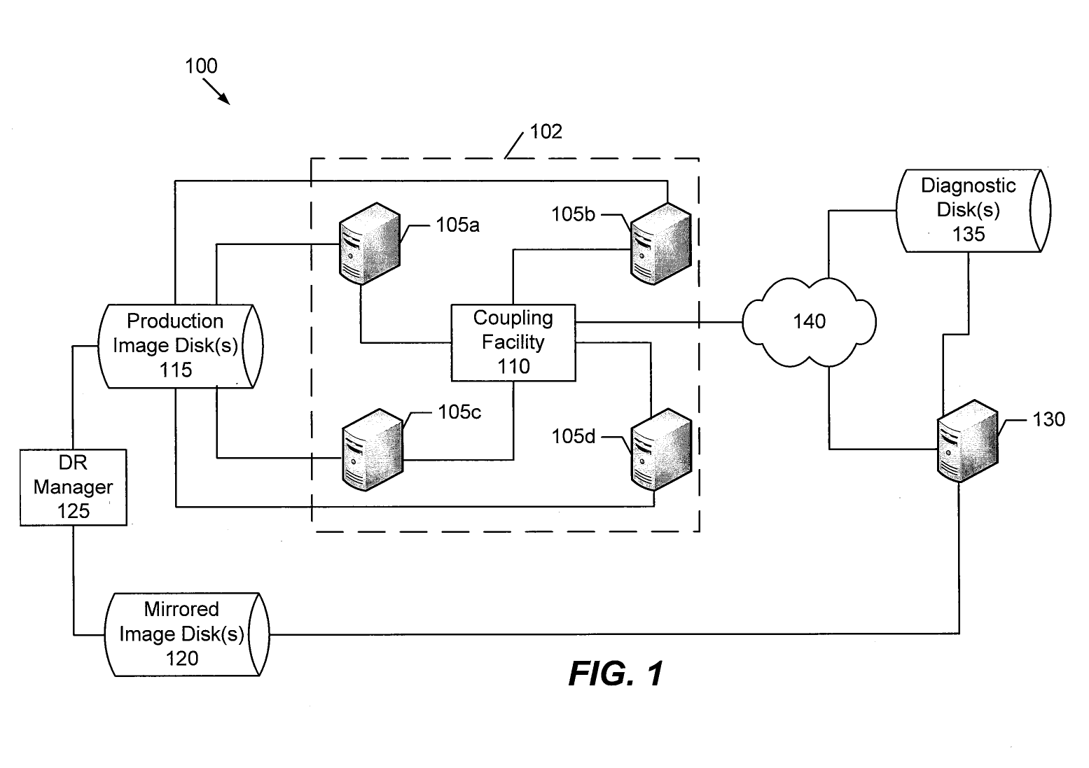

Referring to FIG. 1, a communication network 100 including an experiment computer system for generating diagnostic experiments to evaluate performance anomalies in a production computer system, in accordance with some embodiments of the inventive subject matter, comprises a production computer system 102 that is coupled of an experiment computer system 130 via a network 140. The network 140 may be a global network, such as the Internet or other publicly accessible network. Various elements of the network 140 may be interconnected by a wide area network, a local area network, an Intranet, and/or other private network, which may not be accessible by the general public. Thus, the communication network 140 may represent a combination of public and private networks or a virtual private network (VPN). The network 140 may be a wireless network, a wireline network, or may be a combination of both wireless and wireline networks. In some embodiments of the inventive subject matter, the production computer system 102 may be an IBM Parallel Sysplex computer system, which comprises Logical Partitions (LPARs) 105a, 105b, 105c, and 105d, which are connected by a Coupling Facility (CF) 110. Each LPAR 105a, 105b, 105c, and 105d is a subset of a computer's hardware resources, virtualized as a separate computer. That is, a physical machine may be partitioned into multiple LPARs, each hosting a separate operating system. In accordance with various embodiments of the inventive subject matter, the CF 110 resides on a dedicated stand-alone server configured with processors that can run Coupling Facility control code (CFCC) as integral processors on the production computer system 102 itself configured as ICFs (Internal Coupling Facilities), or as normal LPARs. The CF 110 contains Lock, List, and Cache structures to help with serialization, message passing, and buffer consistency between the LPARs 105a, 105b, 105c, and 105d. The production computer system 102 is coupled to one or more production image disk drives 115 that contain the image of the software and data that executes on the production computer system 102. The production computer system 102 may further include a Disaster Recovery (DR) manager 125 that is configured to periodically create backups of the image from the production image disk(s) 115 for storage on the mirrored image disk(s) 120. The experiment computer system 130 may be coupled to the mirrored image disks 120 through the network 140 or via a separate connection as shown in FIG. 1 in accordance with various embodiments of the inventive subject matter. As will be described in detail herein, system monitor software may be used to monitor the performance of the production computer system 102 and detect performance anomalies. When one or more anomalies are detected that affect the productivity of the production computer system 102 to such a degree that they are deemed worthy of further diagnosis and possible correction, then the DR manager 125 may terminate updates to the image stored on the mirrored image disk(s) 120 and diagnostic information may be collected on the one or more performance anomalies and communicated to the experiment computer system 130 for storage on the diagnostic disk(s) 135. In some embodiments, the experiment computer system 130 and/or the diagnostic disk(s) 135 may be instantiated in the cloud, for example, in response to detection of the one or more performance anomalies by the performance monitoring software. This may alleviate costs that may be associated with having a dedicated processing system allocated for performance diagnostics and experiments when the dedicated processing system may be idle for extended periods of time.

Although FIG. 1 illustrates an exemplary communication network including an experiment computer system 130 for generating diagnostic experiments to evaluate performance anomalies in a production computer system 102, it will be understood that embodiments of the inventive subject matter are not limited to such configurations, but are intended to encompass any configuration capable of carrying out the operations described herein.

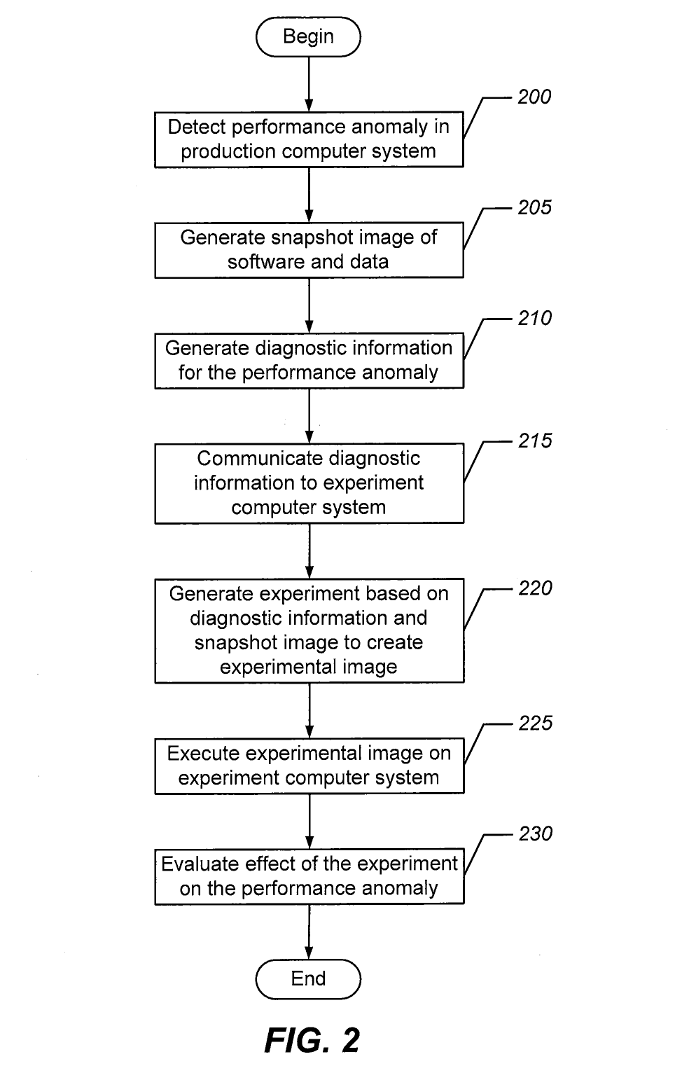

FIGS. 2-9 are flowcharts that illustrate operations for generating diagnostic experiments to evaluate performance anomalies in a production computer system 102 in accordance with some embodiments of the inventive subject matter. Referring now to FIG. 2, operations begin at block 200 where performance system monitoring software may detect one or more performance anomalies in the production computer system 102. At block 205, a snapshot image of the software and data that were executed on the production computer system 102 during the one or more performance anomalies is generated. In some embodiments, the snapshot may be obtained by the DR manager 125 terminating the updates to the backup images stored on the mirrored image disk(s) 120 generated from the production image stored on the production image disk(s) 115. Diagnostic information may be generated for the one or more performance anomalies at block 210 and this diagnostic information may be communicated to the experiment computer system 130 at block 215. The experiment computer system 130 may be configured to generate one or more experiments based on diagnostic information that has been provided by the performance system monitoring software and the snapshot image that has been created on the mirrored image disk(s) 120 to create an experimental image. As will be described herein, the experimental image, in accordance with various embodiments of the inventive subject matter, may include software modifications to address code bottlenecks, software modifications to address inefficient access to data components, and/or architectural changes to data components. The experiment may also include the generation of an experimental load, such as the use of data transactions with a data component that are obtained from a log of data transactions on the production computer system 102. When the performance anomaly is associated with batch processing, the jobs in the critical path can be identified and their sequence changed and/or certain jobs may be configured for execution in parallel as part of the experiment. The experimental image is executed on the experiment computer system 130 at block 225. Various combinations of the software changes, data component architecture changes, transaction load, and critical path modifications can be performed as part of one or more experiments. At block 230, the experiment(s) are evaluated to determine the effect on the performance anomaly to see if the problem is resolved/negative effects are mitigated or if the experiment(s) had no effect on the performance anomaly. Even if the experiment(s) result in the determination that the change(s) made had no beneficial performance effect, such information may be useful in ruling out potential causes of the performance problem. Based on the evaluation, a fix or performance enhancement may be determined and the production computer system 102 may be modified to include the fix or enhancement to improve the performance thereof. A cost/benefit analysis may be performed to determine if the cost of generating and installing a fix to improve performance does not exceed the costs associated with the one or more performance anomalies.

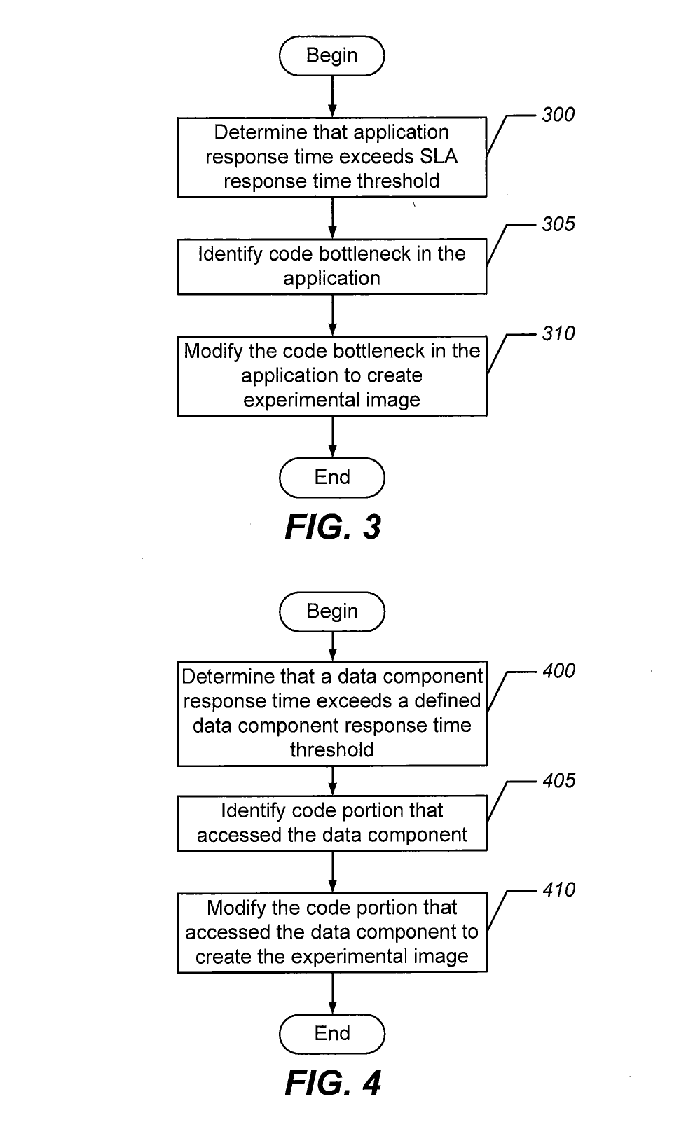

Referring now to FIG. 3, in some embodiments of the inventive subject matter, the experimental image may include software modifications to address code bottlenecks. Operations begin at block 300 where the performance anomaly is detected by determining that an application response time exceeds a response time threshold that may be defined, for example, in a Service Level Agreement (SLA) between the computing provider and a customer or end user. The diagnostic information may be generated by identifying a code bottleneck in the application at block 305. The experimental image may be created at block 310 to include a modification of the code bottleneck in the application. The modification may include direct changes to the code bottleneck itself and/or changes in code that interacts with the code bottleneck in accordance with various embodiments of the inventive subject matter.

Referring now to FIG. 4, in some embodiments of the inventive subject matter, the experimental image may include software modifications to address response time anomalies in accessing a data component. Operations begin at block 400 where the performance anomaly is detected by determining that a data component response time exceeds a defined data component response time threshold. The diagnostic information may be generated by identifying a code portion that accessed the data component at block 405. The experimental image may be created at block 410 to include a modification of the code portion that accessed the data component. The modification may include direct changes to the code portion that accessed the data component itself and/or changes in code that interacts with the code portion that accessed the data component in accordance with various embodiments of the inventive subject matter.

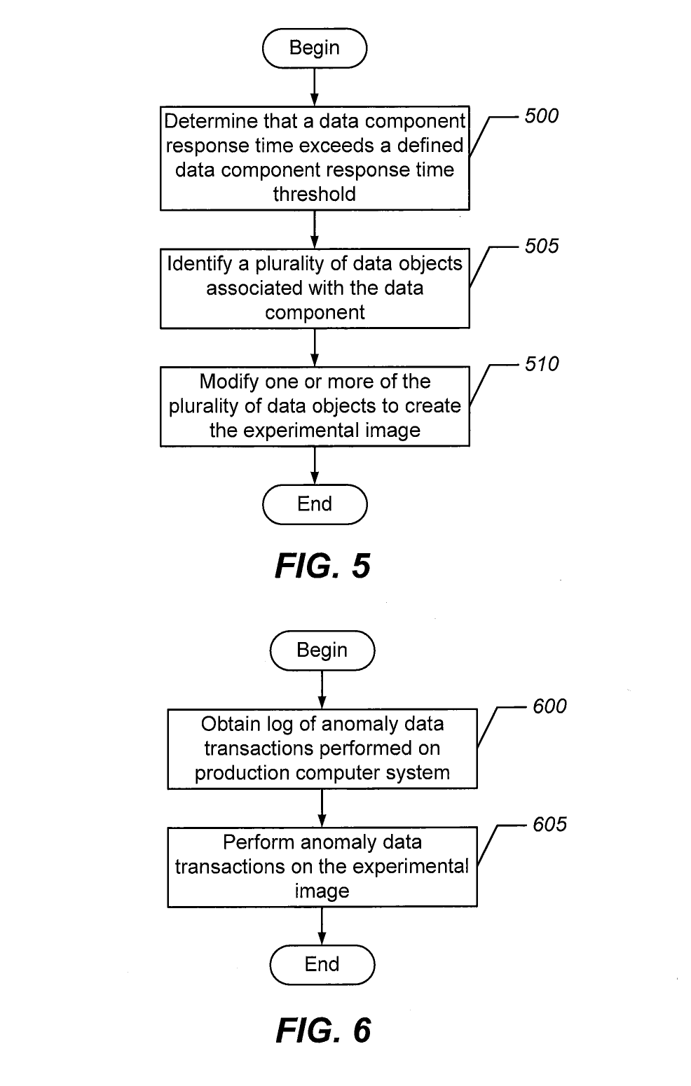

Referring now to FIG. 5, in some embodiments of the inventive subject matter, the experimental image may include architectural changes to data components to improve response times. Operations begin at block 500 where the performance anomaly is detected by determining that a data component response time exceeds a defined data component response time threshold. The diagnostic information may be generated by identifying a plurality of data objects associated with the data component at block 505. The experimental image may be created at block 510 to include a modification of one or more of the plurality of data objects. In some embodiments of the inventive subject matter, the data component is a DB2 data component and the plurality of data objects include, but are not limited to, a database, a storage group, a table space, a table, an index, a view, a catalog, and/or a directory. In some embodiments, generating the diagnostic information at block 505 by identifying the plurality of data objects may comprise executing a DB2 RUNSTATS utility on one or more of the plurality of data objects. The RUNSTATS utility gathers summary information about the characteristics of data in table spaces, indexes, and partitions. DB2 records these statistics in the DB2 catalog and uses them to select access paths to data during the bind process. In some embodiments, generating the experimental image at block 510 may comprise executing a DB2 REORG TABLESPACE utility on one or more of the plurality of data objects, executing an archive on one or more of the plurality of data objects, and/or executing a DB2 REBUILD INDEX utility on one or more of the plurality of data objects. The DB2 REORG TABLESPACE utility reorganizes a table space to improve access performance and to reclaim fragmented space. In addition, the utility can reorganize a single partition or range of partitions of a partitioned table space. The DB2 REBUILD INDEX utility reconstructs indexes or index partitions from the table that the indexes/partitions reference.

Referring now to FIG. 6, in some embodiments of the inventive subject matter, the experiment(s) may also include the generation of an experimental load. Operations begin at block 600 where the experiment computer system 130 obtains a log of anomaly data transactions that were performed on the production computer system 102 during the performance anomaly time interval. During execution of the experimental image on the experiment computer system 130, the anomaly data transactions may be performed at block 605 to reproduce a similar data transactional load that was present during the time the one or more performance anomalies occurred.

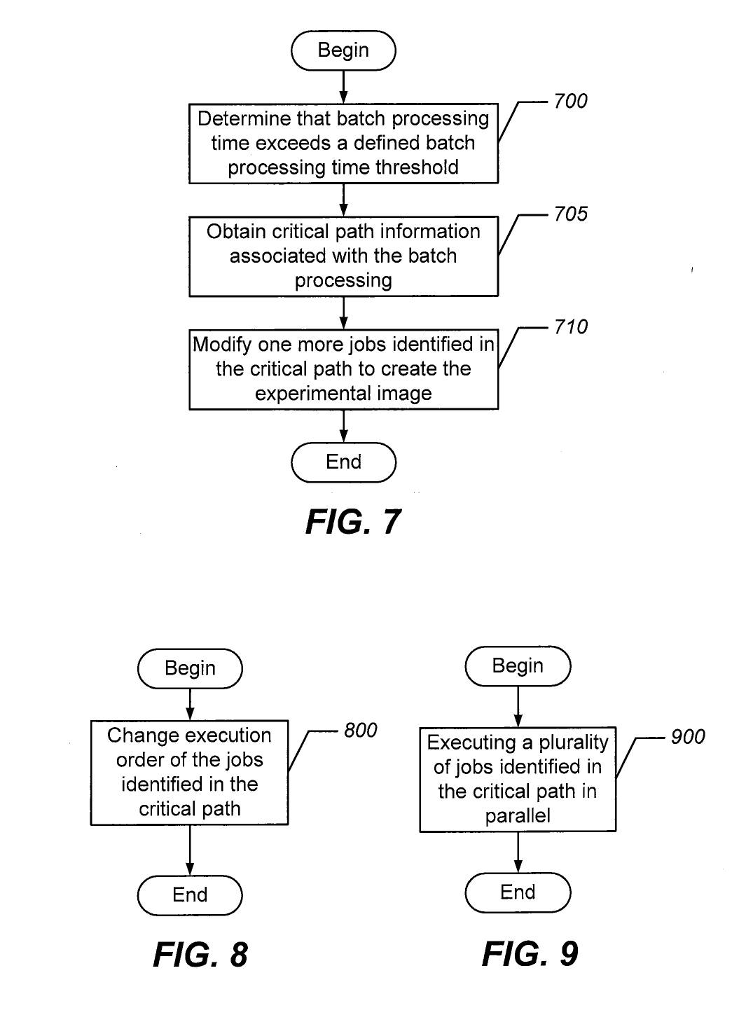

Referring now to FIG. 7, one or more performance anomalies are associated with batch processing. Operations begin at block 700 where the performance anomaly is detected by determining that a batch processing time exceeds a defined batch processing time. The diagnostic information may be generated by obtaining critical path information associated with the batch processing at block 705. The experimental image may be created at block 710 by modifying one or more jobs identified in the critical path. Thus, embodiments of the inventive subject matter may provide improvements to the critical path to determine how the total elapsed time for performing batch processing can be reduced. Various techniques can be used independently or in combination to reduce the total elapsed time associated with the critical path. For example, referring to block 800 of FIG. 8, the execution order of the jobs identified in the critical path can be changed to adjust the dependencies between jobs. Referring to block 90Q of FIG. 9, multiple jobs identified in the critical path may be executed in parallel. Such experimentation with both the execution order and/or applying parallelism to various jobs in the critical path may reduce total elapsed time dedicated to batch processing.

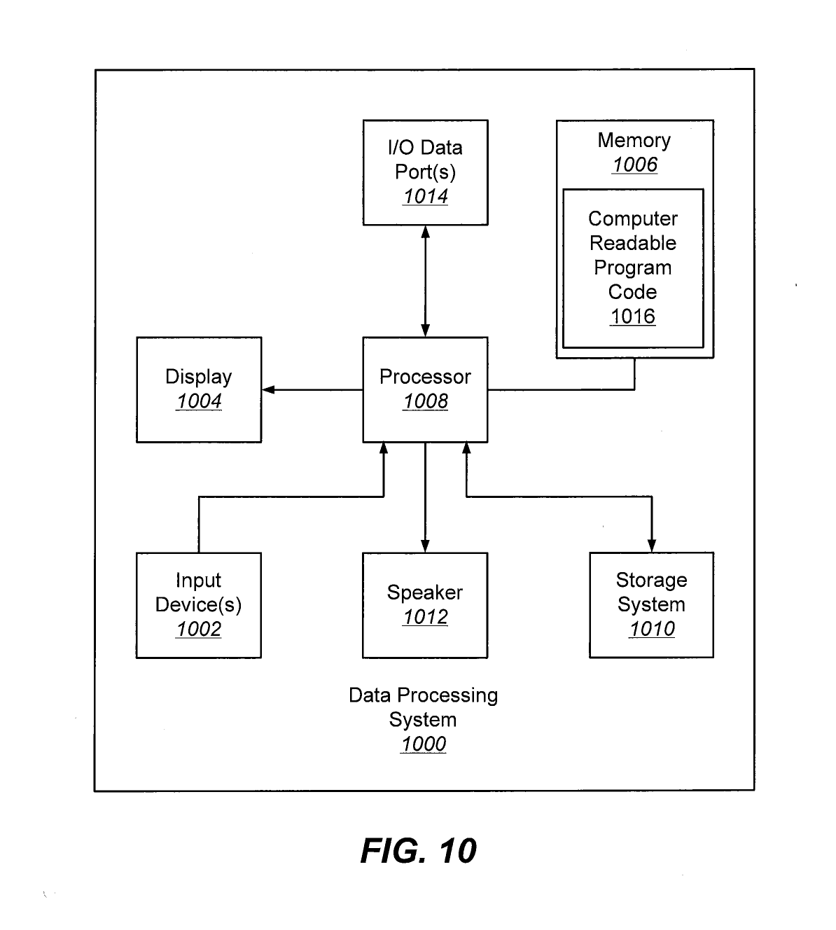

Referring now to FIG. 10, a data processing system 1000 that may be used to implement one or more servers or processors in the experiment computer system 130 and production computer system 102 of FIG. 1, in accordance with some embodiments of the inventive subject matter, comprises input device(s) 1002, such as a keyboard or keypad, a display 1004, and a memory 1006 that communicate with a processor 1008. The data processing system 1000 may further include a storage system 1010, a speaker 1012, and an input/output (I/O) data port(s) 1014 that also communicate with the processor 1008. The processor 1008 may be, for example, a commercially available or custom microprocessor. The storage system 1010 may include removable and/or fixed media, such as floppy disks, ZIP drives, hard disks, or the like, as well as virtual storage, such as a RAMDISK. The I/O data port(s) 1014 may be used to transfer information between the data processing system 1000 and another computer system or a network (e.g., the Internet). These components may be conventional components, such as those used in many conventional computing devices, and their functionality, with respect to conventional operations, is generally known to those skilled in the art. The memory 1006 may be configured with computer readable program code 1016 to facilitate the generation of diagnostic experiments for evaluating production computer system 102 performance anomalies in accordance with some embodiments of the inventive subject matter.

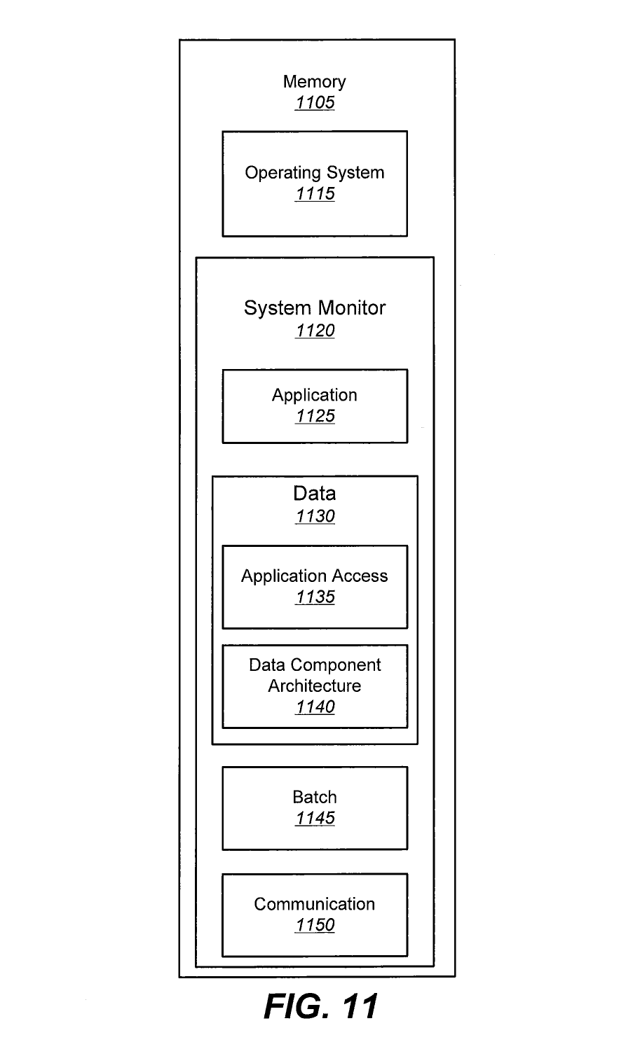

FIG. 11 illustrates a memory 1105 that may be used in embodiments of data processing systems, such as the production computer system 102 of FIG. 1 and the data processing system 1000 of FIG. 10, respectively, to facilitate generation of diagnostic experiments for evaluating computer system performance anomalies in accordance with some embodiments of the inventive subject matter. The memory 1105 is representative of the one or more memory devices containing the software and data used for facilitating operations of the production computer system 102 as described herein. The memory 1105 may include, but is not limited to, the following types of devices: cache, ROM, PROM, EPROM, EEPROM, flash, SRAM, and DRAM.

As shown in FIG. 11, the memory 1105 may contain two or more categories of software and/or data: an operating system 1115 and a system monitor module 1120. In particular, the operating system 1115 may manage the data processing system's software and/or hardware resources and may coordinate execution of programs by the processor. The system monitor module 1120 may comprise an application module 1125, a data module 113Q, a batch module 1145, and a communication module 1150. The system monitor module 1120 may be configured generally to detect one or more performance anomalies in the production computer system 102, to generate a snapshot image of the software and data that were executed on the production computer system 102 at the time of the one or more performance anomalies, and to provide the diagnostic information to the experiment computer system 130 as described above with respect to blocks 200, 205, 210, and 215 of FIG. 2, respectively. The application module 1125 may be configured, for example, to perform one or more of the operations of blocks 300 and 305 of FIG. 3. The data module 1130 may comprise an application access module 1135 and a data component architecture module 1140. The application access module 1135 may be configured, for example, to perform one or more of the operations of blocks 400 and 405 of FIG. 4 and block 600 of FIG. 6. The data component architecture module 1140 may be configured, for example, to perform one or more of the operations of blocks 500 and 505 of FIG. 5. The batch module 1145 may be configured, for example, to perform one or more of the operations of blocks 700 and 705 of FIG. 7. The communication module 1150 may be configured to facilitate communication with the experiment computer system 130.

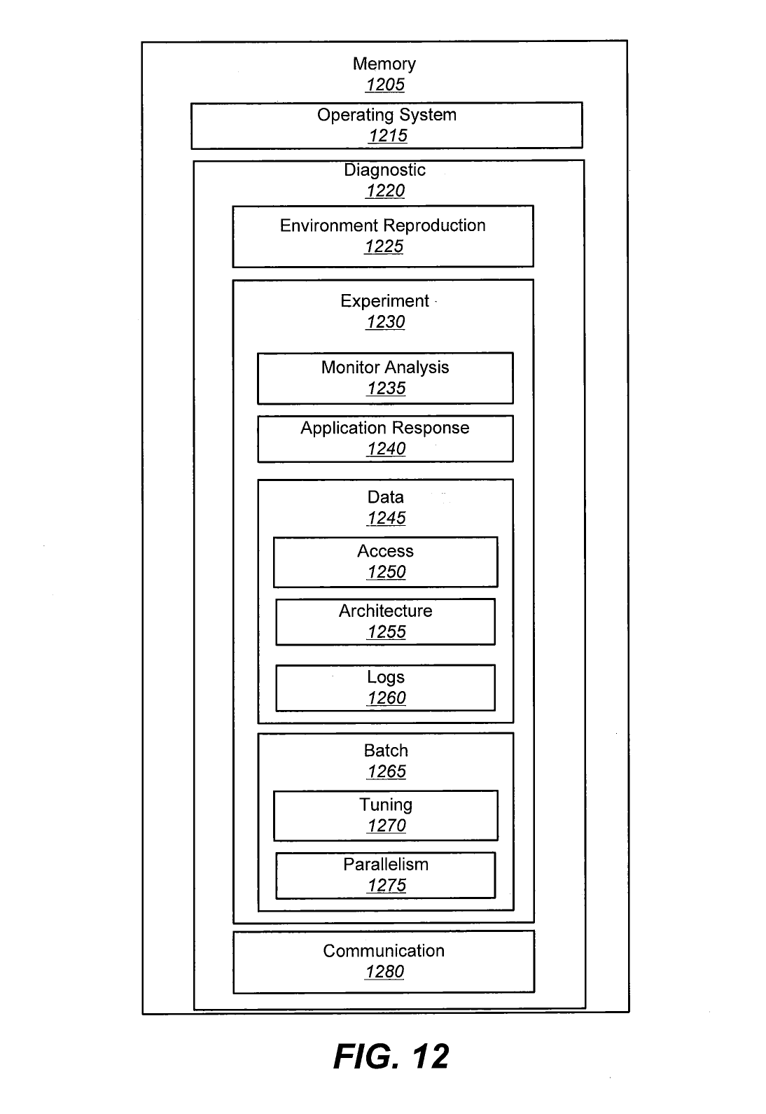

FIG. 12 illustrates a memory 1205 that may be used in embodiments of data processing systems, such as the experiment computer system 130 of FIG. 1 and the data processing system 1000 of FIG. 10, respectively, to facilitate generation of diagnostic experiments for evaluating computer system performance anomalies in accordance with some embodiments of the inventive subject matter. The memory 1205 is representative of the one or more memory devices containing the software and data used for facilitating operations of the experiment computer system 130 as described herein. The memory 1205 may include, but is not limited to, the following types of devices: cache, ROM, PROM, EPROM, EEPROM, flash, SRAM, and DRAM.

As shown in FIG. 12, the memory 1205 may contain two or more categories of software and/or data: an operating system 1215 and a diagnostic module 1220. In particular, the operating system 1215 may manage the data processing system's software and/or hardware resources and may coordinate execution of programs by the processor. The diagnostic module 1220 may comprise an environment reproduction module 1225, an experiment module 1230, and a communication module 1280. The diagnostic module 1220 may be configured generally to generate an experiment based on diagnostic information obtained from production computer system 102 along with a snapshot of the image containing the software and data executed by the production computer system 102 at the time of one or more performance anomalies. The experiment is performed an experimental image that is executed on the experiment computer system 130 and the effect of the experiment on the one or more performance anomalies is evaluated. These operations have been described above, for example, with respect to blocks 220, 225, and 230 of FIG. 2. The environment reproduction module 1225 may be configured, for example, to establish the mirrored image disk(s) 120 or other snapshot image of the software and data executed on the production system 102 during the one or more performance anomalies, which was generated the operation of block 205 of FIG. 2, as the experimental image for performing one or more test experiments. The experiment module 1230 comprises a monitor analysis module 1235, an application response module 1240, a data module 1245, and a batch module 1265. The experiment module 1230 may be configured to generate experiments to evaluate production computer system performance anomalies to determine the cause of the anomalies and/or to determine ways to improve the performance of the production computer system 102. The experiments can be generated automatically by the experiment computer system 130 based on historical data, Artificial Intelligence (AI) techniques, and/or can include user input to customize one or more aspect of the experiments. The monitor analysis module 1235 may be configured to receive and process the diagnostic information for the one or more performance anomalies detected on the production computer system 102. The application response module 1240 may be configured, for example, to perform the operation of block 310. The data module 1245 comprises an access module 1250, an architecture module 1255, and a logs module 1260. The access module 125Q may be configured, for example, to perform the operation of block 410. The architecture module 1255 may be configured to perform the operation of block 510. The logs module 1260 may be configured to perform one or more of the operations of blocks 600 and 605 of FIG. 6. The batch module 1265 comprises a tuning module 1270 and a parallelism module 1275. The tuning module 1270 may be configured, for example, to perform one or more of the operations of block 710 of FIG. 7 and block 800 of FIG. 8. The parallelism module 1275 may be configured to perform one or more of the operations of block 710 of FIG. 7 and block 900 of FIG. 9. The communication module 1280 may be configured to facilitate communication with the experiment computer system production computer system 102 of FIG. 1.

Although FIGS. 10-12 illustrate hardware/software architectures that may be used in data processing systems, such as the production computer system 102 and the experiment computer system 130 of FIG. 1 in accordance with some embodiments of the inventive subject matter, it will be understood that the present invention is not limited to such a configuration but is intended to encompass any configuration capable of carrying out operations described herein.

Computer program code for carrying out operations of data processing systems discussed above with respect to FIGS. 1-12 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the production computer system 102, experiment computer system 130, and the data processing system 1000 of FIG. 10 may each be implemented as a single processor system, a multi-processor system, a multi-core processor system, or even a network of stand-alone computer systems, in accordance with various embodiments of the inventive subject matter. Each of these processor/computer systems may be referred to as a “processor” or “data processing system.”

The data processing apparatus described herein with respect to FIGS. 1-12 may be used to facilitate the generation of diagnostic experiments for evaluating computer system performance anomalies according to various embodiments described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memories 1105 and 1205, respectively, when coupled to a processor include computer readable program code that, when executed by the respective processors, causes the respective processors to perform operations including one or more of the operations described herein with respect to FIGS. 1-9.

Some embodiments of the inventive subject matter, provide an automated system for evaluating production computer system performance anomalies through experimentation on an experiment computer system to evaluate potential fixes or modifications that can improve system performance and/or address the root cause of the performance problems. A cost benefit analysis may be performed to determine whether to launch or instantiate the experiment computer system to perform the experiments. For example, SLAs may proscribe fines owed to a customer or end user for a computer system that is operating at a performance level that fails to meet a defined standard or threshold. These fines may be weighed against the costs associated with invoking the experiment computer system to perform the experiments to fix and/or reduce the impact of the performance problems in the production computer system. The costs in performing the experiments may include the computational and memory costs associated with the experiment computer system along with the personnel costs associated with performing and evaluating the experiment results and modifying the production computer system based on these results.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, LabVIEW, dynamic programming languages, such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

It will be understood that, although the terms “first,” “second,” etc. may be used herein to describe various elements, these elements should not be limited by these terms. These terms are only used to distinguish one element from another. Thus, a first element could be termed a second element without departing from the teachings of the inventive subject matter.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described to best explain the principles of the disclosure and the practical application, and to enable others of ordinary skill in the art to understand the disclosure with various modifications as are suited to the particular use contemplated.

What is claimed is:

1. A method comprising:
performing by a processor:
detecting a performance anomaly in a production computer system;
generating a snapshot image of software and data that were executed on the production computer system during the performance anomaly;
generating diagnostic information for the performance anomaly;
communicating the diagnostic information to an experiment computer system;
generating an experiment based on the diagnostic information and the snapshot image to create an experimental image;
executing the experimental image on the experiment computer system to perform the experiment; and
evaluating an effect of the experiment on the performance anomaly.

2. The method of claim 1, wherein detecting the performance anomaly comprises:
determining that an application response time exceeds a service level agreement application response time threshold; and
wherein generating the diagnostic information comprises:
identifying a code bottleneck in the application.

3. The method of claim 2, wherein generating the experiment comprises:
modifying the code bottleneck in the application to create the experimental image.

4. The method of claim 1, wherein detecting the performance anomaly comprises:
determining that a data component response time exceeds a defined data component response time threshold.

5. The method of claim 4, wherein generating the diagnostic information comprises:
identifying a code portion that accessed the data component.

6. The method of claim 5, wherein generating the experiment comprises:
modifying the code portion that accessed the data component to create the experimental image.

7. The method of claim 4, wherein generating the diagnostic information comprises:
identifying a plurality of data objects associated with the data component.

8. The method of claim 7, wherein the data component is a DB2 data component and the plurality of data objects comprise a database, a storage group, a table space, a table, an index, a view, a catalog, and/or a directory.

9. The method of claim 8, wherein generating the diagnostic information further comprises:
executing a RUNSTATS utility on at least one of the plurality of data objects.

10. The method of claim 8, wherein generating the experiment comprises at least one of:
executing a REORG utility on at least one of the plurality of data objects to create the experimental image;
executing an archive on at least one of the plurality of data objects to create the experimental image; and/or
executing a REBUILD INDEX utility on at least one of the plurality of data objects to create the experimental image.

11. The method of claim 1, wherein generating the experiment comprises:
obtaining a log of anomaly data transactions performed on the production computer system during the performance anomaly; and
wherein executing the experimental image comprises:
performing the anomaly data transactions on the experimental image.

12. The method of claim 1, wherein detecting the performance anomaly comprises:
determining that a batch processing time exceeds a defined batch processing time threshold; and
wherein generating the diagnostic information comprises:
obtaining critical path information associated with the batch processing, the critical path information identifying jobs scheduled for execution as part of the batch processing.

13. The method of claim 12, wherein generating the experiment comprises:
modifying at least one of the jobs identified in the critical path information to create the experimental image.

14. The method of claim 13, wherein modifying at least one of the jobs comprises:
changing an execution order of the at least one of the jobs relative to other ones of the jobs identified in the critical path information.

15. The method of claim 12, wherein executing the experimental image comprises:
executing a plurality of the jobs identified in the critical path information in parallel.

16. The method of claim 1, wherein generating the snapshot image comprises:
terminating updates to a disaster recovery backup image of the software and data used on the production computer system responsive to detecting the performance anomaly; and
using the disaster recovery backup image as the snapshot image responsive to terminating updates to the disaster recovery backup image.

17. A system, comprising:
a processor; and
a memory coupled to the processor and comprising computer readable program code embodied in the memory that is executable by the processor to perform:
detecting a performance anomaly in a production computer system;
generating a snapshot image of software and data that were executed on the production computer system during the performance anomaly;
generating diagnostic information for the performance anomaly;
communicating the diagnostic information to an experiment computer system;
generating an experiment based on the diagnostic information and the snapshot image to create an experimental image;
executing the experimental image on the experiment computer system to perform the experiment; and
evaluating an effect of the experiment on the performance anomaly;
wherein detecting the performance anomaly comprises:
determining that a data component response time exceeds a defined data component response time;
wherein generating the diagnostic information comprises:
identifying a code portion that accessed the data component; and
identifying a plurality of data objects associated with the data component.

18. The system of claim 17, wherein the data component is a relational database.

19. A computer program product comprising:
a tangible computer readable storage medium comprising computer readable program code embodied in the medium that is executable by a processor to perform:
detecting a performance anomaly in a production computer system;
generating a snapshot image of software and data that were executed on the production computer system during the performance anomaly;
generating diagnostic information for the performance anomaly;
communicating the diagnostic information to an experiment computer system;
generating an experiment based on the diagnostic information and the snapshot image to create an experimental image;
executing the experimental image on the experiment computer system to perform the experiment; and
evaluating an effect of the experiment on the performance anomaly;
wherein the production computer system is a IBM Parallel Sysplex computer system; and
wherein the experiment computer system is a cloud computing resource.

20. The computer program product of claim 19, wherein the snapshot image is a disaster recovery backup image of the software and data used on the production computer system.
